(19) United States
(12) Patent Application Publication
(10) Pub. No.: US 2025/0079435 A1
(43) Pub. Date: Mar. 6, 2025

(54) POWER STORAGE CELL

(71) Applicant: TOYOTA JIDOSHA KABUSHIKI KAISHA, Toyota-shi (JP)

(72) Inventors: Kazuhito KATO, Toyota-shi (JP); Junta TAKASU, Nagoya-shi (JP); Atsushi YAMANAKA, Nagoya-shi (JP); Masato ONO, Nagoya-shi (JP); Satoshi MORIYAMA, Nagoya-shi (JP); Kosuke SUZUKI, Toyota-shi (JP); Kazuki SUGIE, Miyoshi-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 18/616,618

(22) Filed: Mar. 26, 2024

(30) Foreign Application Priority Data
Aug. 30, 2023 (JP) 2023-139896

(51) Int. Cl. H01M 4/13; H01M 10/0587

(52) U.S. Cl. CPC H01M 4/13; H01M 10/0587

(57) ABSTRACT

A cathode sheet (first electrode sheet) of a power storage cell includes a long side (first long side) located at an end portion on a Z1 side (one side in an axial direction). An anode sheet (second electrode sheet) includes a long side (second long side) located at an end portion on the Z1 side. The cathode sheet includes a cathode current collector (first current collector) and a cathode composite material layer (first electrode material layer). A cathode uncoated portion of the cathode current collector is formed on the long side and includes a plurality of piece portions (first piece portions) disposed in an X direction (winding direction). An insulating portion (first insulating portion, insulating member) is formed on the long side of the anode sheet.

### CROSS-REFERENCE TO RELATED APPLICATION

This application claims priority to Japanese Patent Application No. 2023-139896 filed on Aug. 30, 2023, incorporated herein by reference in its entirety.

### BACKGROUND

### 1. Technical Field

The present disclosure relates to a power storage cell.

### 2. Description of Related Art

US20160104875 A1 discloses a battery cell including an electrode body with electrode sheets (a cathode sheet and an anode sheet) wound into a scroll pattern. The electrode sheet is wound with a cathode sheet and an anode sheet overlapping each other with a separator in between.

### SUMMARY

Here, although not specified in the US20160104875 A1, a plurality of piece portions (metal pieces) may be provided at an axial end of an electrode sheet. For example, when a plurality of piece portions of a cathode sheet (first electrode sheet) is bent, the piece portions may come into contact with an anode sheet (second electrode sheet).

The present disclosure has been made to solve the above issue, and a purpose of the present disclosure is to provide a power storage cell that can suppress the piece portions provided at an axial end of the first electrode sheet from coming into contact with the second electrode sheet.

A power storage cell according to an aspect of the present disclosure includes: a wound electrode body including a first electrode sheet, a second electrode sheet, and a separator disposed between the first electrode sheet and the second electrode sheet; and an insulating member. Each of the first electrode sheet and the second electrode sheet is elongated in shape in a winding direction of the wound electrode body. The first electrode sheet includes a first long side located at an end portion on one side in an axial direction in which a winding axis of the wound electrode body extends. The second electrode sheet includes a second long side located at an end portion on the one side in the axial direction. The first electrode sheet includes a first current collector including a first electrode material layer, a first coated portion provided with the first electrode material layer, and a first uncoated portion to which the first electrode material layer is not applied. The first uncoated portion is provided on the first long side and includes a plurality of first piece portions disposed in the winding direction. The insulating member includes a first insulating portion provided on the second long side.

In the power storage cell according to the aspect of the present disclosure, as described above, the piece portions are provided on the first long side located at one end in the axial direction of the first electrode sheet, and the first insulating portion is provided on the second long side located at one end in the axial direction of the second electrode sheet. Accordingly, even when the first piece portions are bent toward the second electrode sheet, the first insulating portion can suppress the first piece portions from coming into contact (being electrically connected) with the second electrode sheet.

In the power storage cell according to the aspect, preferably, the first electrode sheet may include a third long side located at an end on another side in the axial direction. The second electrode sheet may include a fourth long side located at an end on the other side in the axial direction. The second electrode sheet may include a second electrode material layer, and a second current collector including a second coated portion provided with the second electrode material layer and a second uncoated portion to which the second electrode material layer is not applied. The second uncoated portion may be provided on the fourth long side and may include a plurality of second piece portions disposed in the winding direction. The insulating member may include a second insulating portion provided on the third long side. With this configuration, even when the second piece portions are bent toward the first electrode sheet, the second insulating portion can suppress the second piece portions from coming into contact (being electrically connected) with the first electrode sheet.

In the power storage cell according to the aspect, preferably, the insulating member may be made of a porous material. With this configuration, when an electrolyte solution is injected into the wound electrode body from one side in the axial direction, the electrolyte solution can be introduced into the wound electrode body through the insulating member that is a porous material.

In this case, preferably, the insulating member may be provided continuously along the winding direction. With this configuration, contact between the electrode sheet and the piece portions can be more reliably suppressed.

In the power storage cell according to the aspect, preferably, the insulating member may be provided intermittently along the winding direction. With this configuration, a gap is created between the insulating members, so that when the electrolyte solution is injected into the wound electrode body from one side in the axial direction, it is possible to easily suppress the insulating members from interfering with the entry of the electrolyte solution.

According to the present disclosure, it is possible to suppress the piece portions provided at the axial end of the first electrode sheet from coming into contact with the second electrode sheet.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view showing a configuration of a power storage cell according to an embodiment;

FIG. 2 is a schematic perspective view showing a configuration of a wound electrode body according to the embodiment;

FIG. 3 is a plan view showing a configuration of a cathode current collector plate according to the embodiment;

FIG. 4 is a plan view showing a configuration of an anode current collector plate according to the embodiment;

FIG. 5 is a partially enlarged view of the vicinity of the cathode current collector plate in FIG. 1;

FIG. 6 is a partially enlarged view of the vicinity of the anode current collector plate in FIG. 1;

FIG. 7 is a diagram showing a configuration of each of a cathode sheet and an anode sheet in an unwound state according to the embodiment; and

FIG. 8 is a diagram showing a configuration of each of the cathode sheet and the anode sheet in an unwound state according to a modification of the embodiment.

### DETAILED DESCRIPTION OF EMBODIMENTS

An embodiment of the present disclosure will be described in detail below with reference to the drawings. Note that the same reference symbols are given to the same or equivalent portions in the drawings, and the description of such portions will not be repeated.

A power storage cell 100 includes a wound electrode body 1, a case 2, a cathode terminal 3, a cathode current collector plate 4, an external gasket 5, an internal gasket 6, an anode current collector plate 7, a polymer ring 8, and a sealing plug 9.

The wound electrode body 1 is housed in the case 2. The case 2 has a cylindrical shape. The wound electrode body 1 is wound into a cylindrical shape similar to the shape of the case 2. That is, the power storage cell 100 is a cylindrical battery. Note that the case 2 is made of copper, aluminum, or the like.

The case 2 includes a top plate portion 2a, a peripheral wall portion 2c, and a sealing plate 2d. The peripheral wall portion 2c is provided on the outer peripheral side of the wound electrode body 1 and has a cylindrical shape. The top plate portion 2a is connected to an end portion of the peripheral wall portion 2c on a Z1 side. The top plate portion 2a is integrally formed with the peripheral wall portion 2c. The sealing plate 2d is connected to an end portion of the peripheral wall portion 2c on a Z2 side. The sealing plate 2d lids an opening of the peripheral wall portion 2c on the Z2 side. A crimp portion 2e is formed in the end portion of the peripheral wall portion 2c on the Z2 side. In the crimp portion 2e, the peripheral wall portion 2c is crimped along the outer peripheral edge of the sealing plate 2d. The crimp portion 2e is formed in an annular shape.

The wound electrode body 1 includes a cathode sheet 10, an anode sheet 20, and a separator 30. The separator 30 is provided between the cathode sheet 10 and the anode sheet 20. The separator 30 separates the cathode sheet 10 (cathode active material) and the anode sheet 20 (anode active material) while allowing ions (for example, lithium ions) to pass between the cathode sheet 10 and the anode sheet 20. The wound electrode body 1 is constituted by a group of electrode plates in which the cathode sheet 10 and the anode sheet 20 are wound with the separator 30 in between. Note that the cathode sheet 10 and the anode sheet 20 are an example of the “first electrode sheet” and the “second electrode sheet” of the present disclosure, respectively.

As shown in FIG. 2, in the wound electrode body 1, the cathode sheet 10, the anode sheet 20, and the separator 30 are wound to surround a winding axis a. In FIG. 2, the wound electrode body 1 is shown in a slightly unwound state so that a wound state of the wound electrode body 1 can be easily understood.

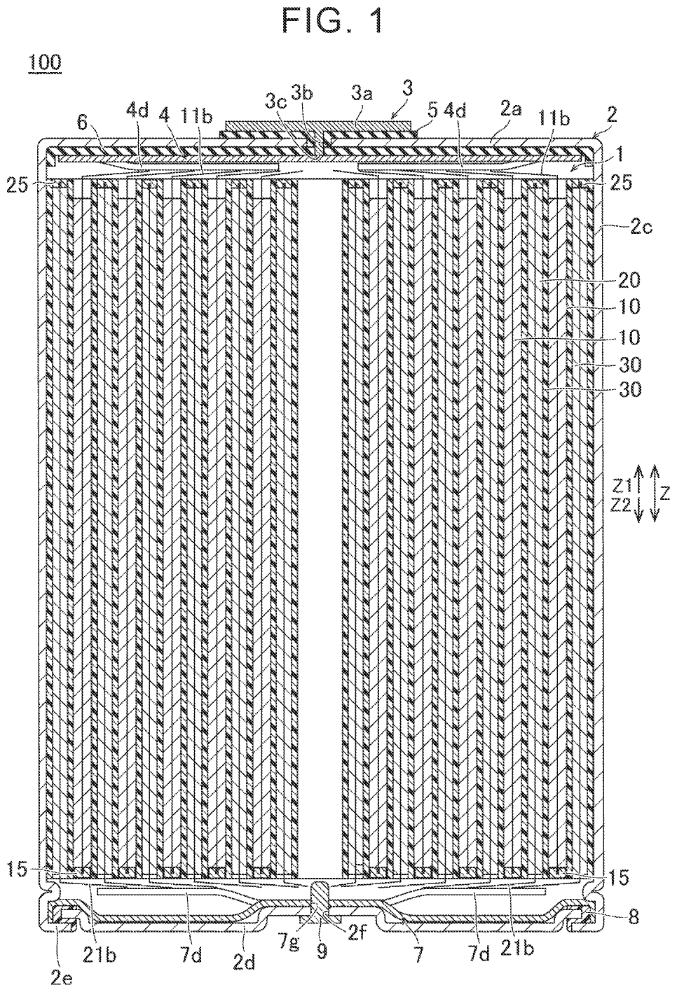

Referring again to FIG. 1, the cathode terminal 3 includes a disk portion 3a and a rivet portion 3b. The disk portion 3a is provided outside the case 2 and is therefore exposed. The rivet portion 3b is connected to the disk portion 3a. The rivet portion 3b is provided so as to extend from the center of the disk portion 3a toward the Z2 side. Note that the cathode terminal 3 is made of aluminum.

The disk portion 3a is disposed on the top plate portion 2a of the case 2. The top plate portion 2a is provided at an end portion of the case 2 on the Z1 side. The top plate portion 2a is provided perpendicular to a Z direction. A through hole 2b (see FIG. 5) is provided in the top plate portion 2a. The rivet portion 3b extends from the disk portion 3a disposed outside the case 2 to the inside of the case 2 through the through hole 2b. Note that the Z direction is an example of the “axial direction” of the present disclosure.

The cathode current collector plate 4 is housed in the case 2. The cathode current collector plate 4 (piece portions 4d described below) is welded to a cathode uncoated portion 11b of the cathode sheet 10, which will be described later. Accordingly, the cathode current collector plate 4 is positively charged. The cathode current collector plate 4 is welded to an end portion 3c of the rivet portion 3b on the Z2 side. Accordingly, the cathode terminal 3 is positively charged.

The external gasket 5 is provided outside the case 2. Specifically, the external gasket 5 is disposed between the disk portion 3a of the cathode terminal 3 and the top plate portion 2a of the case 2. Accordingly, the cathode terminal 3 and the case 2 are insulated.

The internal gasket 6 is provided inside the case 2. Specifically, the internal gasket 6 is disposed between the case 2 and the cathode current collector plate 4. Accordingly, the case 2 and the cathode current collector plate 4 are insulated. Note that the rivet portion 3b is in contact with the cathode current collector plate 4 by penetrating the internal gasket 6.

The anode current collector plate 7 is housed in the case 2. The anode current collector plate 7 (piece portions 7d described below) is welded to an anode uncoated portion 21b of the anode sheet 20, which will be described later. Accordingly, the anode current collector plate 7 is negatively charged. Note that the anode current collector plate 7 is in contact with the case 2. Accordingly, the case 2 is negatively charged.

The polymer ring 8 is provided between the outer peripheral edge of the sealing plate 2d and the crimp portion 2e formed in the peripheral wall portion 2c. The polymer ring 8 has an annular shape.

The sealing plug 9 plugs a through hole 2f provided in the center of the sealing plate 2d. The sealing plug 9 passes through the through hole 2f and also a through hole 7g provided in the center of the anode current collector plate 7.

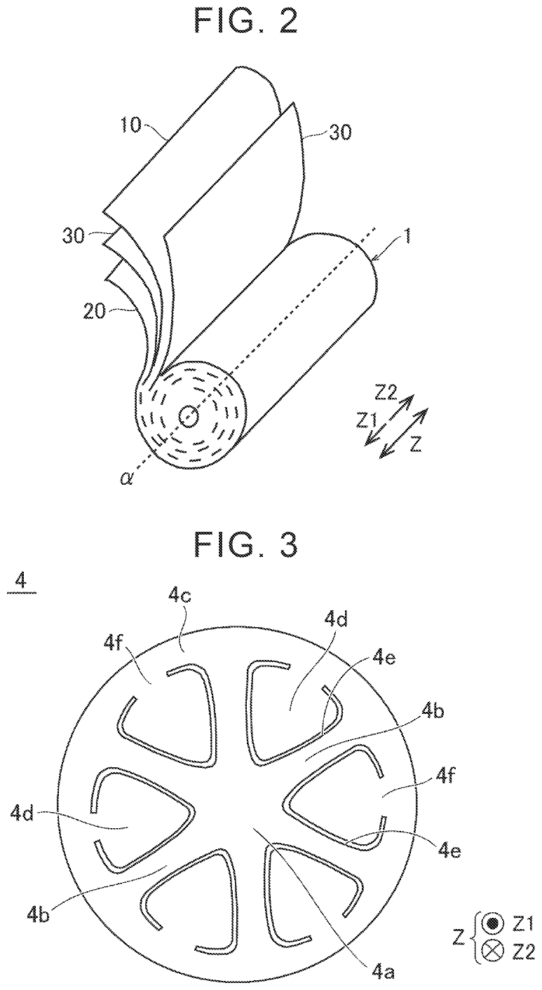

FIG. 3 is a plan view of the cathode current collector plate 4. The cathode current collector plate 4 has a disk shape. The cathode current collector plate 4 includes a center portion 4a, spokes 4b, an outer peripheral edge portion 4c, and the piece portions 4d.

The center portion 4a is provided at the center of the cathode current collector plate 4. The rivet portion 3b is joined to the center portion 4a. The spokes 4b are provided so as to extend radially outward from the center portion 4a. Six spokes 4b are provided at equal angular intervals around the center portion 4a of the cathode current collector plate 4.

The outer peripheral edge portion 4c is provided in the outer peripheral edge of the cathode current collector plate 4. Each of the six spokes 4b connects the outer peripheral edge portion 4c and the center portion 4a. The spokes 4b are formed to warp in the Z direction. Note that the center portion 4a of the cathode current collector plate 4 moves (displaces) the most in the Z direction.

Through holes 4e are each formed between the spokes 4b adjacent to each other in a circumferential direction. That is, six through holes 4e are formed. The piece portions 4d are provided inside the respective six through holes 4c. Each of the six piece portions 4d is connected to the outer peripheral edge portion 4c by a connecting portion 4f. Note that each of the six piece portions 4d has a shape that tapers toward an inner side in a radial direction.

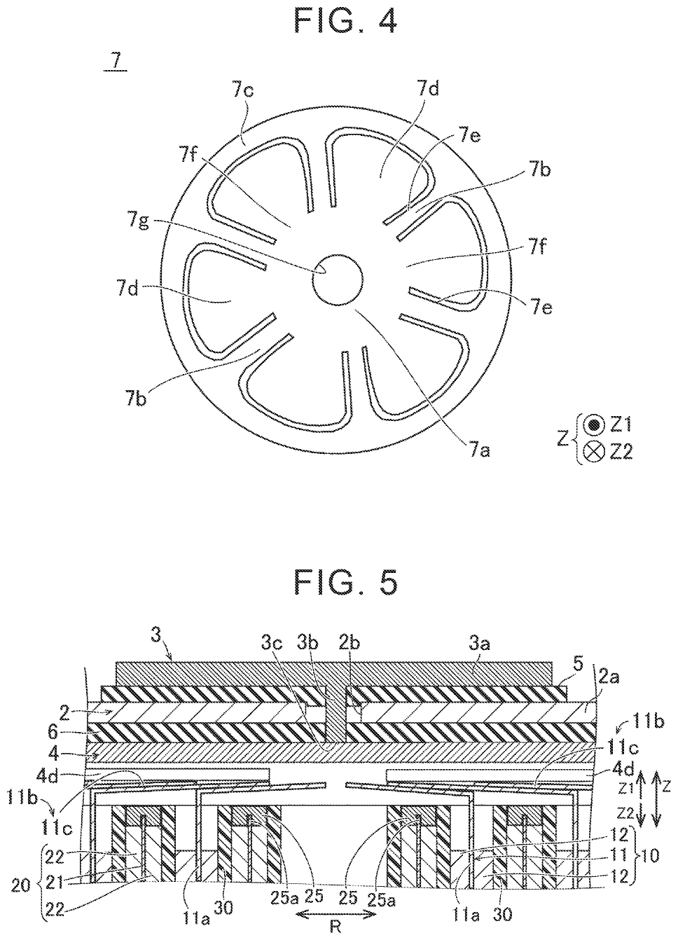

FIG. 4 is a plan view of the anode current collector plate 7. The anode current collector plate 7 has a disk shape. The anode current collector plate 7 includes a center portion 7a, spokes 7b, an outer peripheral edge portion 7c, and the piece portions 7d.

The center portion 7a is provided at the center of the anode current collector plate 7. The spokes 7b are provided so as to extend radially outward from the center portion 7a. Six spokes 7b are provided at equal angular intervals around the center portion 7a of the anode current collector plate 7.

The outer peripheral edge portion 7c is provided in the outer peripheral edge of the anode current collector plate 7. Each of the six spokes 7b connects the outer peripheral edge portion 7c and the center portion 7a. The spokes 7b are formed to warp in the Z direction. The outer peripheral edge portion 7c of the anode current collector plate 7 moves (displaces) the most in the Z direction.

Through holes 7e are each formed between the spokes 7b adjacent to each other in the circumferential direction. That is, six through holes 7e are formed. The piece portions 7d are provided at positions corresponding to the respective six through holes 7e. Specifically, each of the six piece portions 7d is disposed inside a corresponding one of the through holes 7e. Each of the six piece portions 7d is connected to the center portion 7a by a connecting portion 7f. Note that each of the six piece portions 7d has a shape that tapers toward an inner side in the radial direction.

As shown in FIG. 5, the cathode sheet 10 includes a cathode current collector 11 and a cathode composite material layer 12. The cathode composite material layer 12 is applied on both surfaces of the cathode current collector 11 (cathode coated portion 11a to be described later) in the radial direction (R direction). The cathode composite material layer 12 is in close contact with the separator 30. Note that the cathode current collector 11 and the cathode composite material layer 12 are an example of the “first current collector” and the “first electrode material layer”, respectively.

The cathode current collector 11 is made of, for example, aluminum. The cathode composite material layer 12 is formed by applying a cathode slurry to the surfaces of the cathode current collector 11 and drying the cathode slurry. The cathode slurry is a slurry prepared by kneading materials of the cathode composite material layer 12 (cathode active material, binder, etc.) and a solvent. The cathode composite material layer 12 is in close contact with the separator 30. The thickness of the cathode composite material layer 12 is, for example, 0.1 μm or more and 1000 μm or less.

The cathode current collector 11 includes the cathode coated portion 11a and the cathode uncoated portion 11b. The cathode coated portion 11a is a portion of the cathode current collector 11 to which the cathode composite material layer 12 is applied. In other words, the cathode coated portion 11a is a portion that is covered with the cathode composite material layer 12 and is not exposed. Note that the cathode coated portion 11a and the cathode uncoated portion 11b are an example of the “first coated portion” and the “first uncoated portion” of the present disclosure, respectively.

The cathode uncoated portion 11b is an exposed portion of the cathode current collector 11 that is not covered with the cathode composite material layer 12 and an insulating portion 15 described below. The cathode uncoated portion 11b is located closer to the Z1 side than the cathode coated portion 11a. Specifically, the cathode uncoated portion 11b protrudes from the cathode coated portion 11a toward the Z1 side. Note that the Z1 side is an example of “one side in the axial direction” of the present disclosure.

The cathode uncoated portion 11b is bent inward in the radial direction by contacting the cathode current collector plate 4 disposed on the Z1 side. Accordingly, the cathode current collector plate 4 is positively charged. Note that the cathode uncoated portion 11b is joined to the cathode current collector plate 4 by welding.

The cathode uncoated portion 11b includes a plurality of piece portions 11c. The piece portions 11c are disposed along a winding direction of the wound electrode body 1. Note that the piece portions 11c are an example of the “first piece portion” of the present disclosure.

The anode sheet 20 includes an anode current collector 21 and an anode composite material layer 22. The anode composite material layer 22 is applied on both surfaces of the anode current collector 21 (anode coated portion 21a to be described later) in the radial direction (R direction). The anode composite material layer 22 is in close contact with the separator 30. Note that the anode current collector 21 and the anode composite material layer 22 are an example of the “second current collector” and the “second electrode material layer” of the present disclosure, respectively.

The anode current collector 21 is made of copper, for example. The anode composite material layer 22 is formed by applying an anode slurry to the surfaces of the anode current collector 21 and drying the anode slurry. The anode slurry is a slurry prepared by kneading materials of the anode composite material layer 22 (anode active material, binder, etc.) and a solvent. The thickness of the anode composite material layer 22 is, for example, 0.1 μm or more and 1000 μm or less.

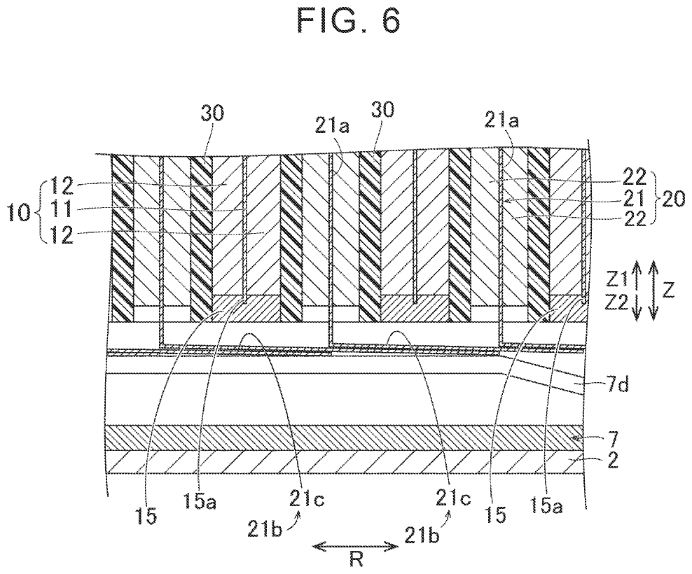

As shown in FIG. 6, the anode current collector 21 includes the anode coated portion 21a and the anode uncoated portion 21b. The anode coated portion 21a is a portion of the anode current collector 21 to which the anode composite material layer 22 is applied. In other words, the anode coated portion 21a is a portion that is covered with the anode composite material layer 22 and is not exposed. Note that the anode coated portion 21a and the anode uncoated portion 21b are an example of the “second coated portion” and the “second uncoated portion” of the present disclosure, respectively.

The anode uncoated portion 21b is an exposed portion of the anode current collector 21 that is not covered with the anode composite material layer 22 and an insulating portion 25 described below. The anode uncoated portion 21b is located closer to the Z2 side than the anode coated portion 21a. Specifically, the anode uncoated portion 21b protrudes from the anode coated portion 21a toward the Z2 side. Note that the Z2 side is an example of “the other side in the axial direction” of the present disclosure.

The anode uncoated portion 21b is bent inward in the radial direction by contacting the anode current collector plate 7 disposed on the Z2 side. Accordingly, the anode current collector plate 7 is negatively charged. Note that the anode uncoated portion 21b is joined to the anode current collector plate 7 by welding.

The anode uncoated portion 21b includes a plurality of piece portions 21c. The piece portions 21c are disposed along the winding direction of the wound electrode body 1. Note that the piece portions 21c are an example of the “second piece portion” of the present disclosure.

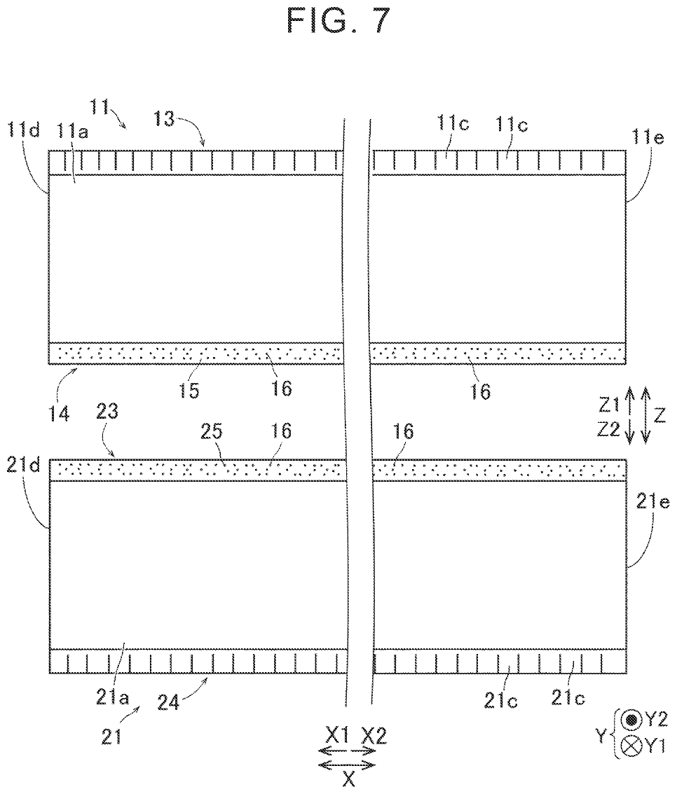

As shown in FIG. 7, each of the cathode sheet 10 (cathode current collector 11) and the anode sheet 20 (anode current collector 21) is formed to be elongated in the winding direction of the wound electrode body 1. Note that the winding direction of the wound electrode body 1 is a direction (an X direction in FIG. 7) in which the cathode sheet 10 (anode sheet 20) extends in an unwound and spread state.

The cathode sheet 10 includes a long side 13 and a long side 14. The long side 13 is located at an end portion of the cathode sheet 10 on the Z1 side. The long side 14 is located at an end portion of the cathode sheet 10 on the Z2 side. The cathode uncoated portion 11b (the piece portions 11c) is provided on the long side 13. The piece portions 11c are disposed side by side along the X direction. Note that the long side 13 and the long side 14 are an example of the “first long side” and the “third long side” of the present disclosure, respectively.

The anode sheet 20 includes a long side 23 and a long side 24. The long side 23 is located at an end portion of the anode sheet 20 on the Z1 side. The long side 24 is located at an end portion of the anode sheet 20 on the Z2 side. The anode uncoated portion 21b (the piece portions 21c) is provided on the long side 24. The piece portions 21c are disposed side by side along the X direction. Note that the long side 23 and the long side 24 are an example of the “second long side” and the “fourth long side” of the present disclosure, respectively.

Here, in the configuration of a conventional power storage cell, for example, when a plurality of piece portions of a cathode sheet is bent, the piece portions may come into contact with an anode sheet.

Therefore, in this embodiment, the power storage cell 100 includes the insulating portion 25 formed on the long side 23 of the anode sheet 20. In the insulating portion 25, an insulating material is applied to a portion 25a (see FIG. 5) of the anode current collector 21 to which the anode composite material layer 22 is not applied. The portion 25a corresponds to the long side 23, and is a portion provided at an end portion of the anode current collector 21 on the Z1 side. Note that the insulating portion 25 is an example of the “first insulating portion” and the “insulating member” of the present disclosure.

Furthermore, the power storage cell 100 includes the insulating portion 15 formed on the long side 14 of the cathode sheet 10. In the insulating portion 15, an insulating material is applied to a portion 15a (see FIG. 6) of the cathode current collector 11 to which the cathode composite material layer 12 is not applied. The portion 15a corresponds to the long side 14, and is a portion provided at an end portion of the cathode current collector 11 on the Z2 side. Note that the insulating portion 15 is an example of the “second insulating portion” and the “insulating member” of the present disclosure.

As shown in FIG. 5, the insulating portion 25 covers the portion 25a so that the portion 25a is not exposed. Specifically, the insulating portion 25 is formed to cover the portion 25a from both sides in the radial direction and from the Z1 side. Accordingly, the cathode uncoated portion 11b (piece portions 11c) and the portion 25a are reliably insulated.

Note that, as described above, the insulating portion 25 is applied to the portion 25a of the anode current collector 21 to which the anode composite material layer 22 is not applied. This suppresses generation of a step at the boundary between the portion 25a to which the insulating portion 25 is applied and the portion (21a) to which the anode composite material layer 22 is applied. Consequently, it is possible to suppress stress from being applied to the anode sheet 20 when the wound electrode body 1 expands and contracts.

As shown in FIG. 6, the insulating portion 15 covers the portion 15a so that the portion 15a is not exposed. Specifically, the insulating portion 15 is formed to cover the portion 15a from both sides in the radial direction and from the Z2 side. Accordingly, the anode uncoated portion 21b (piece portions 21c) and the portion 15a are reliably insulated.

Furthermore, as described above, the insulating portion 15 is applied to the portion 15a of the cathode current collector 11 to which the cathode composite material layer 12 is not applied. This suppresses generation of a step at the boundary between the portion 15a to which the insulating portion 15 is applied and the portion (11a) to which the cathode composite material layer 12 is applied. Consequently, it is possible to suppress stress from being applied to the cathode sheet 10 when the wound electrode body 1 expands and contracts.

As shown in FIG. 7, the insulating portion 15 is formed continuously in the X direction. That is, the insulating portion 15 is constituted by a single member extending in the X direction. Similarly, the insulating portion 25 is formed continuously in the X direction. That is, the insulating portion 25 is constituted by a single member extending in the X direction.

Specifically, the insulating portion 15 is formed to extend from an end portion 11d (for example, a portion from which winding begins) of the cathode sheet 10 on an X1 side to an end portion Ile (a portion in which winding ends) of the cathode sheet 10 on an X2 side. The insulating portion 25 is formed to extend from an end portion 21d (a portion from which winding begins) of the anode sheet 20 on the X1 side to an end portion 21c (a portion in which winding ends) of the anode sheet 20 on the X2 side.

Furthermore, in this embodiment, each of the insulating portion 15 and the insulating portion 25 is formed of a porous material. Specifically, each of the insulating portion 15 and the insulating portion 25 is made of alumina. In FIG. 7, pores 16 contained in alumina are shown as dots to indicate that each of the insulating portion 15 and the insulating portion 25 is a porous material.

Accordingly, each of the insulating portion 15 and the insulating portion 25 can pass gas and liquid. Consequently, it is possible to suppress the insulating portion 15 and the insulating portion 25 from interfering with injection of an electrolyte solution.

Furthermore, since alumina has heat resistance, each of the insulating portion 15 and the insulating portion 25 can suppress heat from being applied to the separator and the like. Therefore, it is possible to suppress heat from being applied to the separator and the like when welding the piece portions 11c and the cathode current collector plate 4, when welding the piece portions 21c and the anode current collector plate 7, and the like.

As described above, in this embodiment, the insulating portion 25 is formed on the long side 23 of the anode sheet 20. Accordingly, the insulating portion 25 can electrically isolate the cathode uncoated portion 11b (piece portions 11c) of the cathode sheet 10 from the long side 23 of the anode sheet 20. Consequently, it is possible to suppress conduction between the cathode sheet 10 and the anode sheet 20.

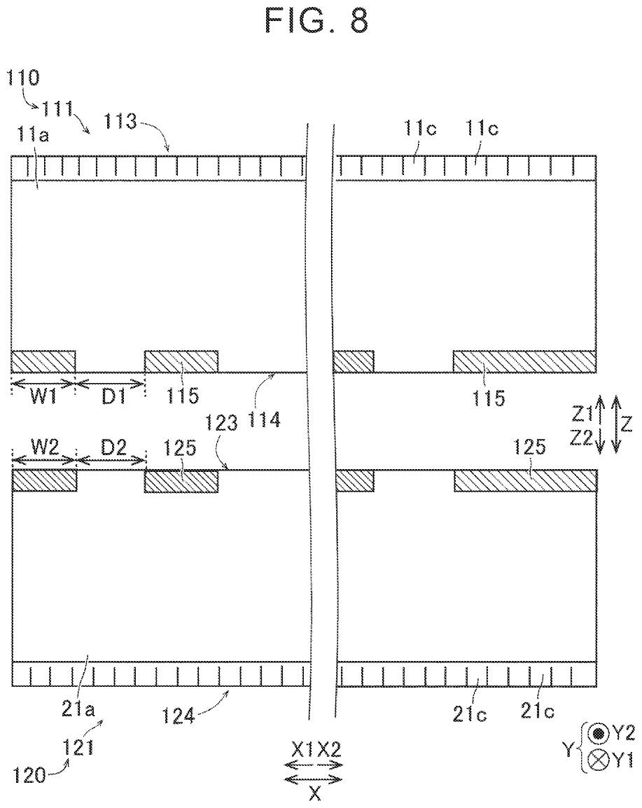

FIG. 8 is a diagram showing a modification of the above embodiment. As shown in FIG. 8, a cathode sheet 110 includes a cathode current collector 111, a long side 113, and a long side 114. The long side 113 is located at an end portion of the cathode sheet 110 on the Z1 side. The long side 114 is located at an end portion of the cathode sheet 110 on the Z2 side. The piece portions 11c are provided on the long side 113. Insulating portions 115 (shaded portions in FIG. 8) are formed on the long side 114. Note that the cathode sheet 110 and the cathode current collector 111 are an example of the “first electrode sheet” and the “first current collector” of the present disclosure, respectively. Furthermore, the long side 113 and the long side 114 are an example of the “first long side” and the “second long side” of the present disclosure, respectively. Furthermore, the insulating portions 115 are an example of the “second insulating portion” and the “insulating member” of the present disclosure.

The insulating portions 115 are formed intermittently along the X direction. A distance D1 between the insulating portions 115 is larger as the positions of the insulating portions 115 are closer to the X2 side (a side on which winding ends). Furthermore, a width W1 of the insulating portion 115 in the X direction is larger as the position of the insulating portion 115 is closer to the X2 side (the side on which winding ends). Accordingly, in a state in which the cathode sheet 110 is wound, layers in which the insulating portions 115 are formed and layers in which the insulating portions 115 are not formed are alternately disposed. Note that the width W1 and the distance D1 may be constant regardless of the positions of the insulating portions 115 in the X direction.

The anode sheet 120 includes an anode current collector 121, a long side 123, and a long side 124. The long side 123 is located at an end portion of the anode sheet 120 on the Z1 side. The long side 124 is located at an end portion of the anode sheet 120 on the Z2 side. The piece portions 21c are provided on the long side 124. Insulating portions 125 (shaded portions in FIG. 8) are formed on the long side 123. Note that the anode sheet 120 and the anode current collector 121 are an example of the “second electrode sheet” and the “second current collector” of the present disclosure, respectively. Furthermore, the long side 123 and the long side 124 are an example of the “first long side” and the “second long side” of the present disclosure, respectively. Furthermore, the insulating portions 125 are an example of the “first insulating portion” and the “insulating member” of the present disclosure.

The insulating portions 125 are formed intermittently along the X direction. A distance D2 between the insulating portions 125 is larger as the positions of the insulating portions 125 are closer to the X2 side (the side on which winding ends). Furthermore, a width W2 of the insulating portion 125 in the X direction is larger as the position of the insulating portion 125 is closer to the X2 side (the side on which winding ends). Accordingly, in a state in which the anode sheet 120 is wound, layers in which the insulating portions 125 are formed and layers in which the insulating portions 125 are not formed are alternately disposed. Note that the width W2 and the distance D2 may be constant regardless of the positions of the insulating portions 125 in the X direction.

Furthermore, each of the insulating portion 115 and the insulating portion 125 need not be formed of a porous material as the above embodiment. For example, the insulating portion 115 may be made of polypropylene. Furthermore, the insulating portion 125 may be made of polyethylene, for example. Each of the insulating portion 115 and the insulating portion 125 may be formed of a porous material. In addition, one of the cathode-side insulating portion and the anode-side insulating portion may be formed continuously in the X direction, and the other of the cathode-side insulating portion and the anode-side insulating portion may be formed intermittently in the X direction.

In the above embodiment, an example is shown in which an insulating portion is formed in each of the cathode sheet 10 and the anode sheet 20, but the present disclosure is not limited to this. The insulating portion may be formed only on either one of the cathode sheet 10 and the anode sheet 20.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A power storage cell comprising:
a wound electrode body including a first electrode sheet, a second electrode sheet, and a separator disposed between the first electrode sheet and the second electrode sheet; and
an insulating member, wherein
each of the first electrode sheet and the second electrode sheet is elongated in shape in a winding direction of the wound electrode body,
the first electrode sheet includes a first long side located at an end portion on one side in an axial direction in which a winding axis of the wound electrode body extends,
the second electrode sheet includes a second long side located at an end portion on the one side in the axial direction,
the first electrode sheet includes
a first electrode material layer, and
a first current collector including a first coated portion provided with the first electrode material layer and a first uncoated portion to which the first electrode material layer is not applied,
the first uncoated portion is provided on the first long side and includes a plurality of first piece portions disposed in the winding direction, and
the insulating member includes a first insulating portion provided on the second long side.

2. The power storage cell according to claim 1, wherein:
the first electrode sheet includes a third long side located at an end on another side in the axial direction;
the second electrode sheet includes a fourth long side located at an end on the other side in the axial direction;
the second electrode sheet includes
a second electrode material layer, and
a second current collector including a second coated portion provided with the second electrode material layer and a second uncoated portion to which the second electrode material layer is not applied;
the second uncoated portion is provided on the fourth long side and includes a plurality of second piece portions disposed in the winding direction; and
the insulating member includes a second insulating portion provided on the third long side.

3. The power storage cell according to claim 1, wherein the insulating member is made of a porous material.

4. The power storage cell according to claim 3, wherein the insulating member is provided continuously along the winding direction.

5. The power storage cell according to claim 1, wherein the insulating member is provided intermittently along the winding direction.
